(19) United States
(12) Patent Application Publication
(10) Pub. No.: US 2003/0006966 A1
(43) Pub. Date: Jan. 9, 2003

(54) Wireless USB keyboard

(76) Inventors: Sheang Teng Lin, Ban Qiao City (TW); Chris Wang, Taipei (TW); Shih-Jen Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/899,116

(22) Filed: Jul. 6, 2001

(51) Int. Cl. G09G 5/00

(52) U.S. Cl. 345/168

(57) ABSTRACT

This invention is a wireless USB keyboard which comprises a signal encoding device between the keyboard switch key assembly and an emitter RF module. Pressing a keyboard matrix data switch encodes the data as data code for transmission. The emitter RF module transmits the signal to the receiver end, and it is transmitted to a computer via a USB port after decoding. The wireless USB keyboard, which transmits signals to the receiver end after encoding, can effectively transmit key matrix data, which prevents the keyboard signal from interfering with other wireless peripheral devices.

### FIELD OF THE INVENTION

The present invention relates to a wireless USB keyboard that can transmit keyboard key matrix data after encoding to a receiver. The USB keyboard can effectively transmit key signals to avoid causing interference.

### BACKGROUND OF THE INVENTION

An appropriate transmission interface is required between conventional computers and peripheral equipment, and signal cables are used to connect these devices and enable the transmission of signals and data. Wireless signal emitter and receiver modules have recently seen greater use in connecting computers with wireless peripherals. For instance, USB signal emitters can transmit control signals that enable the use of various types of USB peripheral equipment. The purpose of wireless control of computer equipment has been achieved.

The USB signal emitter and receiver modules of wireless peripherals and computer systems mostly use RF module emitters and receivers. Because more and more peripherals are being made wireless, poor allocation of channels can easily tend to cause interference. In addition, when a wireless keyboard gives a remote control wakeup signal to a computer system, because the wireless keyboard must send an identification code signal once every fixed period of time, it is easy for the emitter module to malfunction or cause the remote wakeup signal to not work properly. This is why the development of accurate and efficient keyboard switch signals has become an important issue in the area of wireless keyboards.

### SUMMARY OF THE INVENTION

The primary objective of the present invention is to provide a wireless USB keyboard that can transmit keyboard key matrix data after encoding to a receiver. It can effectively transmit key signals, which allows it to avoid causing interference.

This wireless USB keyboard comprises a signal encoding device between the keyboard key assembly and an emitter RF module. Pressing a keyboard matrix data switch encodes the data as data code for transmission. The emitter RF module transmits the signal to the receiver end, and it is transmitted to a computer via a USB port after decoding.

The wireless USB keyboard, which transmits signals to the receiver end after encoding, can effectively transmit key matrix data, which prevents the keyboard signal from interfering with other wireless peripheral devices.

### BRIEF DESCRIPTION OF THE DRAWING

FIG. 1 shows a block diagram of this invention's structure.

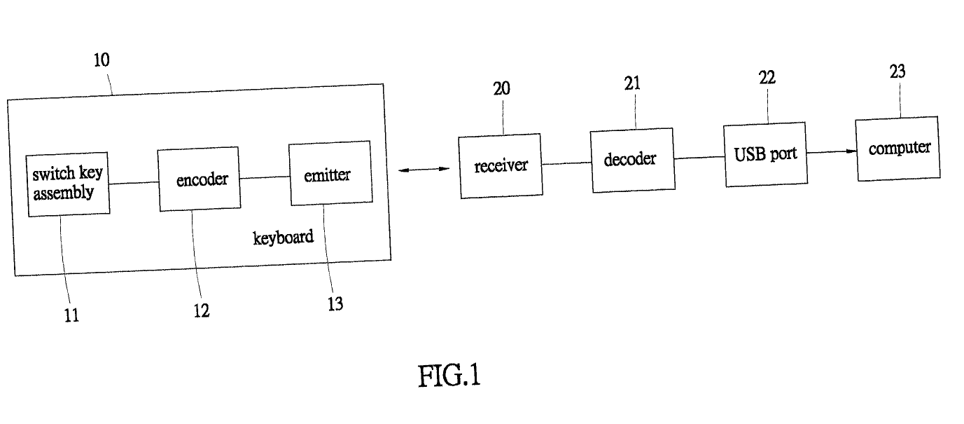

As shown in FIG. 1, the wireless USB keyboard 10 of the present invention comprises a switch key assembly 11, an encoder 12, and a RF emitter 13. In the wireless USB keyboard 10, the switch key assembly 11 refers to several switches arranged in the form of a matrix, and includes scanning software that can detect which keys have been pressed and generate corresponding data signals.

In the wireless USB keyboard 10, the matrix data encoder 12 is installed between the switch key assembly 11 and the signal emitter 13. The matrix data encoder 12 is used to encode matrix data from pressed keyboard switches as a data code prior to transmission. The data code is transmitted by the emitter RF module 13 as a signal, and is received by the receiver end.

At the receiver end, there are a receiver 20, decoder 21, and USB port 22 for connection with a computer system. After encoding, data from keyboard 10 is transmitted by the RF module of emitter 13. It is then received by receiver 20, decoded by decoder 21, and transmitted to computer 23 via USB port 22.

More specifically, key switch matrix data from the wireless USB keyboard 10 is subjected to signal encoding and then transmitted to a receiver, enabling the accurate and effective transmission of key matrix data. Because of this, interference between the key signal and other wireless peripheral devices is avoided.

The invention wireless USB keyboard encodes matrix data before sending it to a receiver. After decoding, the signal is transmitted to a computer via a USB port, enhancing USB signal transmission stability.

What is claimed is:

1. A wireless USB keyboard comprising a switch key assembly, an encoder, and an RF emitter, the switch key assembly having several switches arranged in the form of a matrix, and scanning software which detects which keys have been pressed and generate corresponding data signals, wherein:
a matrix data encoding device is installed between the switch key assembly and the signal emitter;
a matrix data encoding device is used to encode matrix data from pressed keyboard switches as a data code prior to transmission; and
data codes are transmitted by the emitter RF module as a signal, and received by a receiver end.

2. A wireless USB keyboard as claimed in claim 1, wherein the receiver end has a receiver, a decoder, and a USB port for connection with a computer system.
